(19) United States
(12) Patent Application Publication
(10) Pub. No.: US 2009/0287883 A1
(43) Pub. Date: Nov. 19, 2009

(54) Least recently used ADC

(76) Inventor: Srinivas Gadde, Austin, TX (US)

Correspondence Address: Srinivas Gadde, 14300 Tandem Blvd 244, Austin, TX, 78728, US

(21) Appl. No.: 12/119,506

(22) Filed: May 13, 2008

(51) Int. Cl. G06F 12/00

(52) U.S. Cl. 711/118; 711/E12.001

(57) ABSTRACT

During the last 75 years Analog to Digital converters revolutionized the signal processing industry. As transistor sizes reduced, higher resolution of bits is achieved. But FLASH and other full blown faster ADC implementations always consumed relatively higher power. As the analog signal comes into ADC frontend, conversion is initiated from the beginning. ADC conversion process is a highly mathematical number system problem, especially FLASH ADCs are. With faster, low power, and partitioned ADCS, better solutions can be built in so many vast expanding signal processing fields. It is time to come up with logical ADCS instead of brute force, start from the beginning conversion for every sample of analog signal. When the signal does not change abruptly, there is room for applying CACHE principles as it is done in this invention! The approach is to use a smaller ADC for full blown start from the beginning conversions and store it in upfront signal path as CACHED value. Then start using that Cached value set. There must be a balance between number of Cache entries, consumed power, and backend full blown ADC. It is obvious, backend ADC is rarely engaged in conversion when there are too many cache hits, which is desirable.

### BACKGROUND

This invention is used for converting Analog signal to Digital (ADC). A cache scheme is used to store previously converted values of full blown conversions. Those Cache entries are used for future conversions. If there is a cache miss for an analog signal, a fresh full blown conversion is initiated. Upon eviction of one of the previous cache entries, new fresh value is loaded back onto cache structure.

Analog to digital converters are implemented using highly mathematical analysis and design typically. There is a basic full conversion ADC, which is named as backend ADC, in this solution also. By simply focusing on this relatively smaller, one can achieve faster response time. In the future inventions, the backend ADC is shared between multiple ADC channels, because this backend ADC is idle most of the time due to more cache hits (signal does not change that abruptly in some scientific and engineering problems) and lesser cache misses. Only during cache misses the backend ADC is engaged. ADCS are used fundamental in everyday signal processing applications. The natural signal is analog and it needs to be converted to digital for advanced processing using computer and other digital realms.

### SUMMARY

A new analog to digital converter is designed using Cache principles of digital computing. This new approach allowed to drastically reducing backend ADC, which is rarely used for full conversions. Number of cache entries need to be less to offset power consumption in Cache area. Average number of comparators engaged is also less per conversion. If there are more cache entries, power consumption is more. So there must be a balance between Cache, backend ADC, and speed of conversion. So this ADC design used only 4 cache entries. One with better design tools can accurately balance number of cache entries and estimate speed versus power! Optimization. Since cache structure is in the upfront signal path, cache entries are looked first for cache hit (Signal match). It is obvious that Cache lookup is parallel and it consumes more power, but that power is less than the power that is consumed in backend ADC of full initiated conversions. Further optimization is naturally achieved due to the fact that cache behavior reuses previous values that are converted once already. Once a cache miss occurs, full conversion is initiated. LTI (Linear time invariance) is critical in some applications and one can simply calculate worst case time (backend ADC time) as response time for strict LTI. Since backend ADC is logically smaller, more silicon can be added to it, which allows better LTI to be achieved.

### BRIEF DESCRIPTION ON THE DRAWINGS

As shown in FIG. 1A basic cache ADC can be built. Fundamental idea is to compute digital output for an analog input that falls within a particular range. Let's assume previous MSB bits are “0111” (decimal 07). If the next signal falls within the same range that corresponds 0111, then there is no need to use a full stage ADC to compute these already historically (Cache) known digital bits. Then signal ADC CACHE HIT can be raised true, compute the analog difference with OP-SUB 1000 and feed the rest of unresolved signal that corresponds to lower bits.

FIG. 2A shows a single channel ADC that uses the cascaded LRU CACHE ADC stages (basic cells as in FIG. IA).

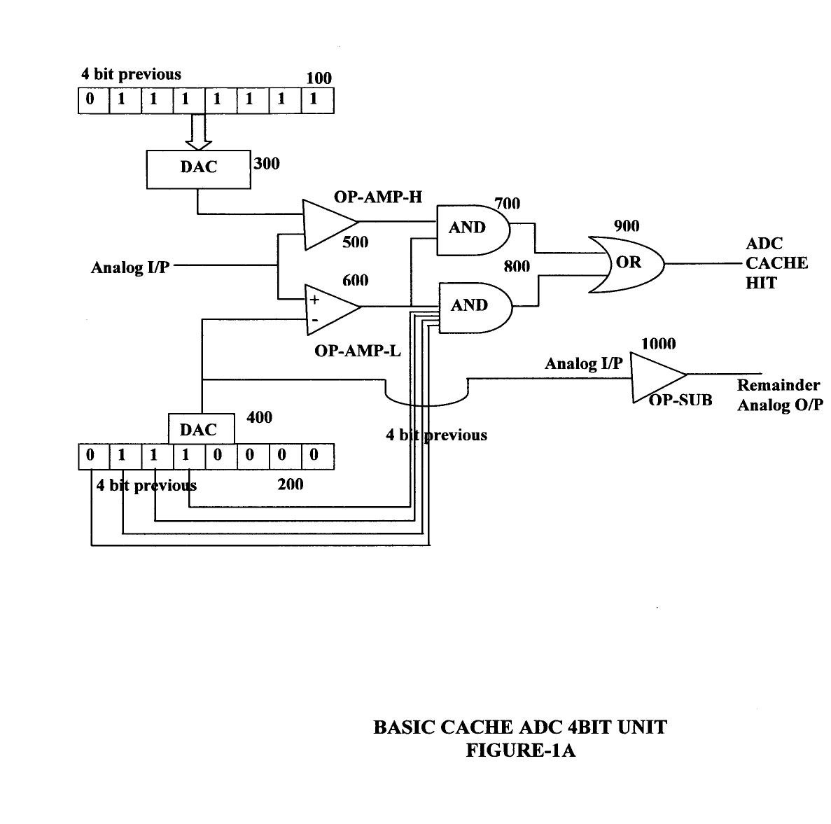

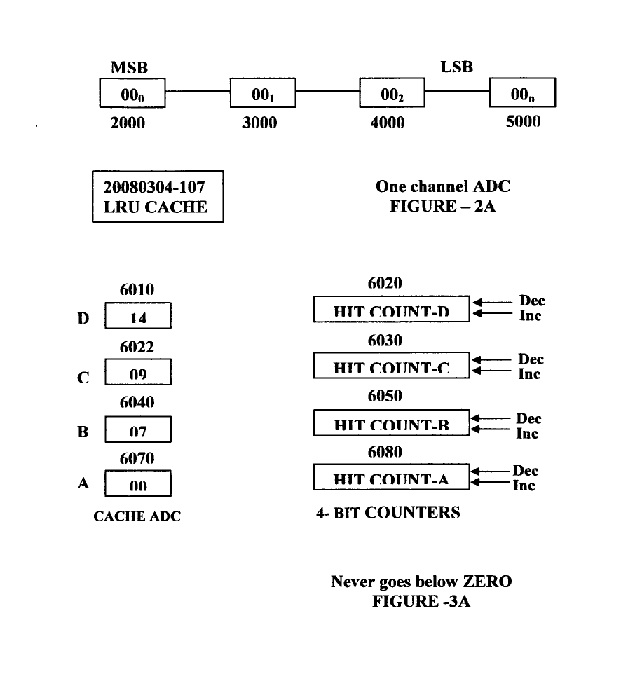

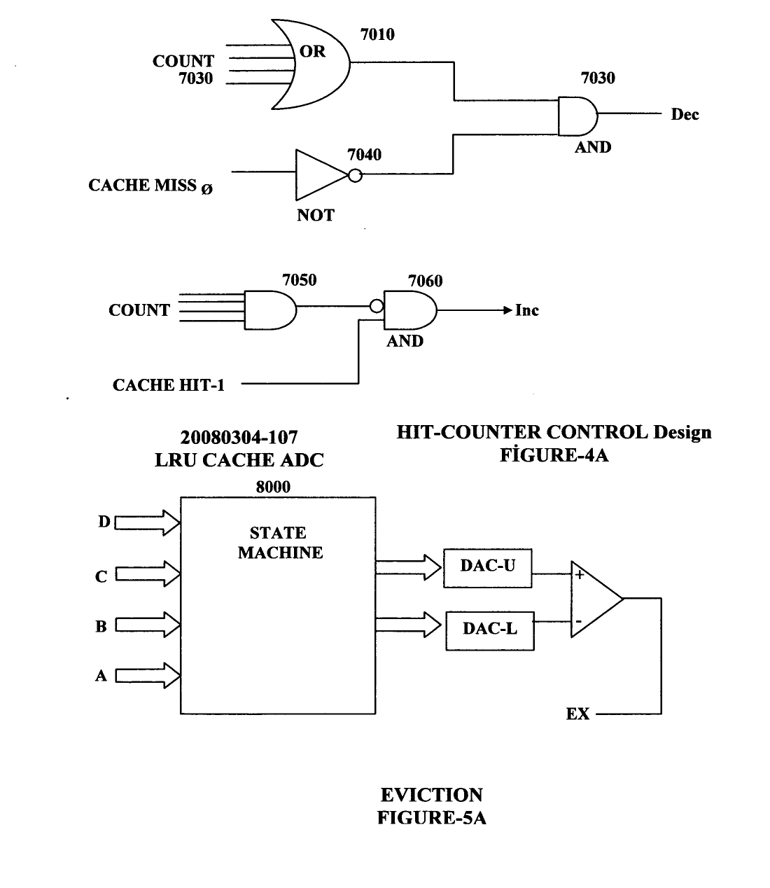

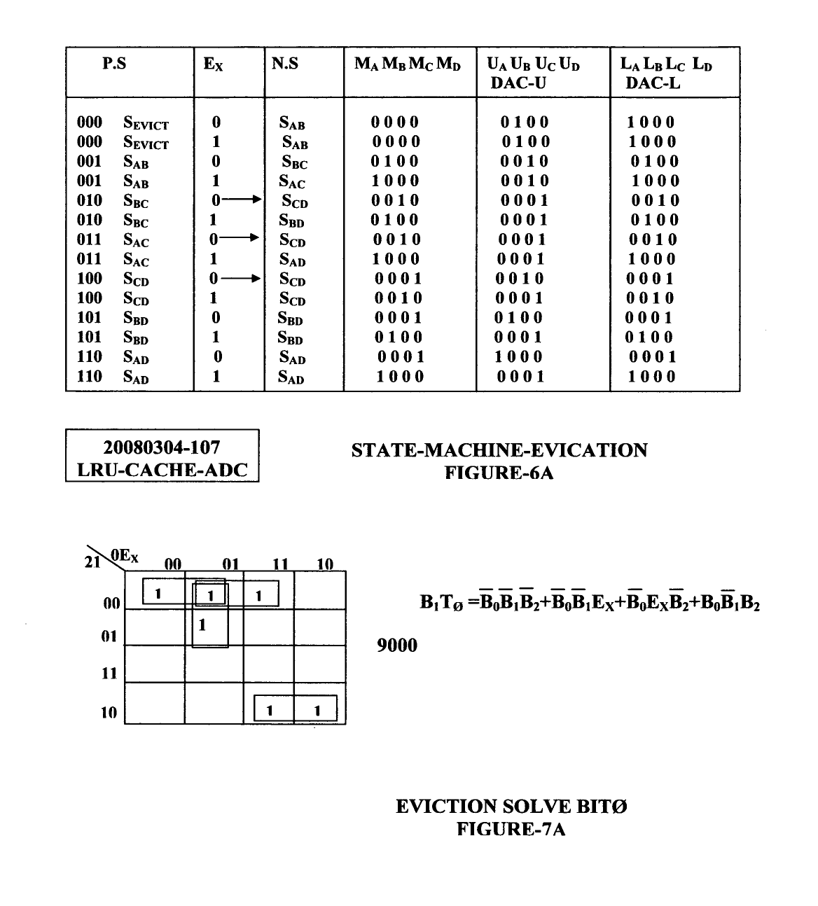

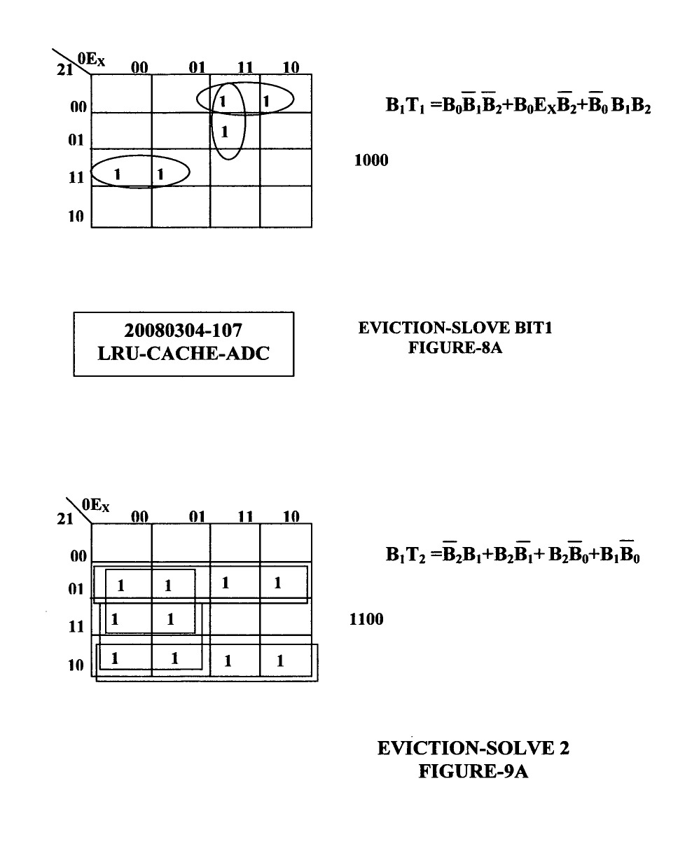

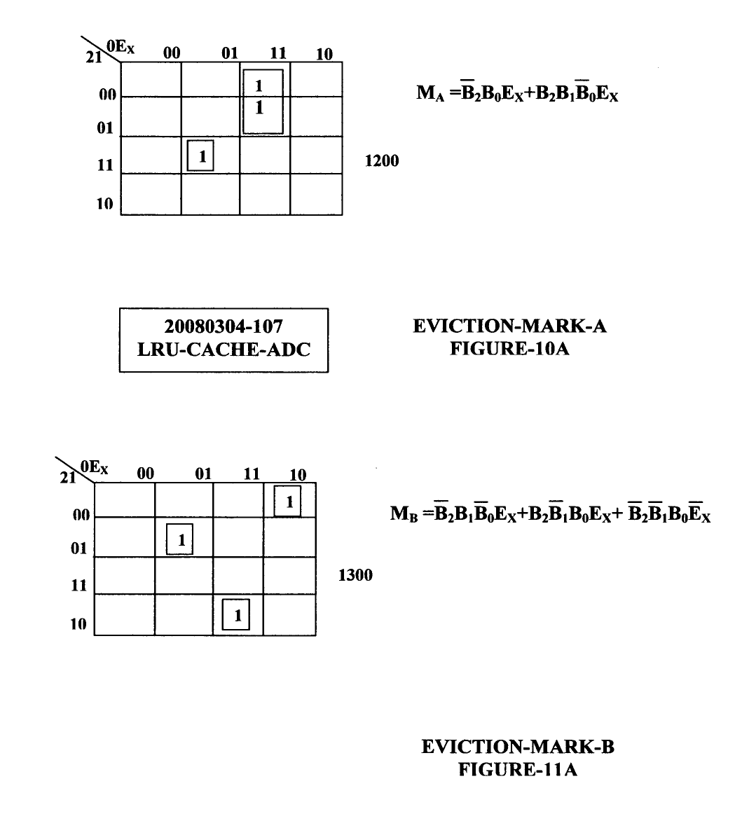

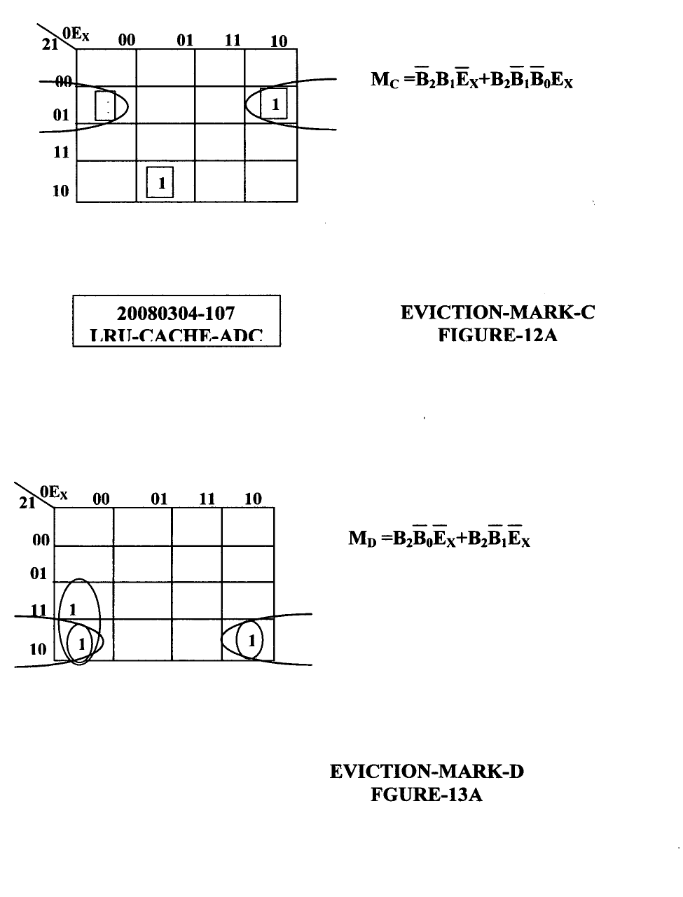

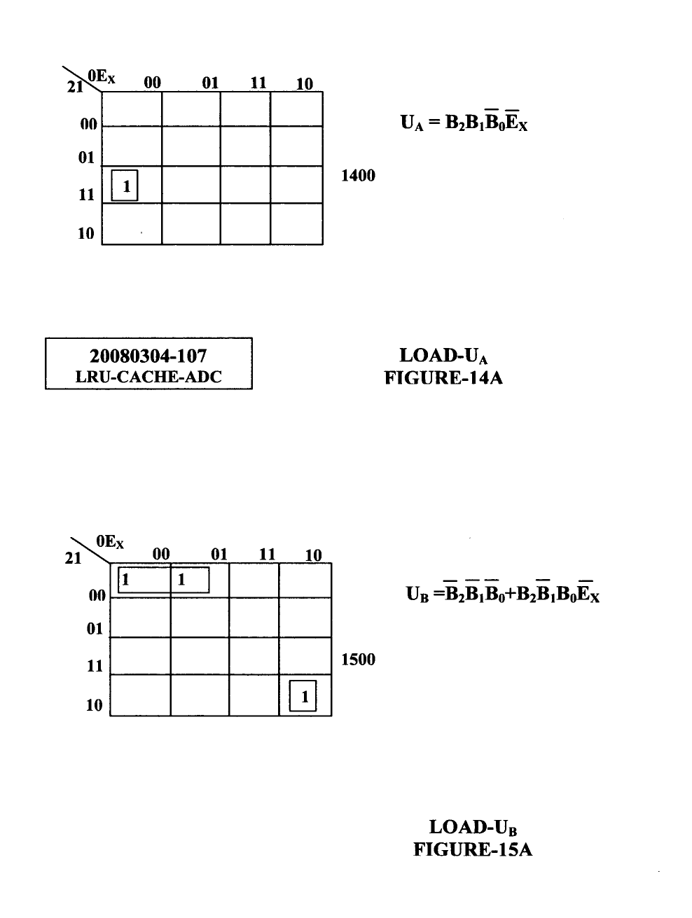

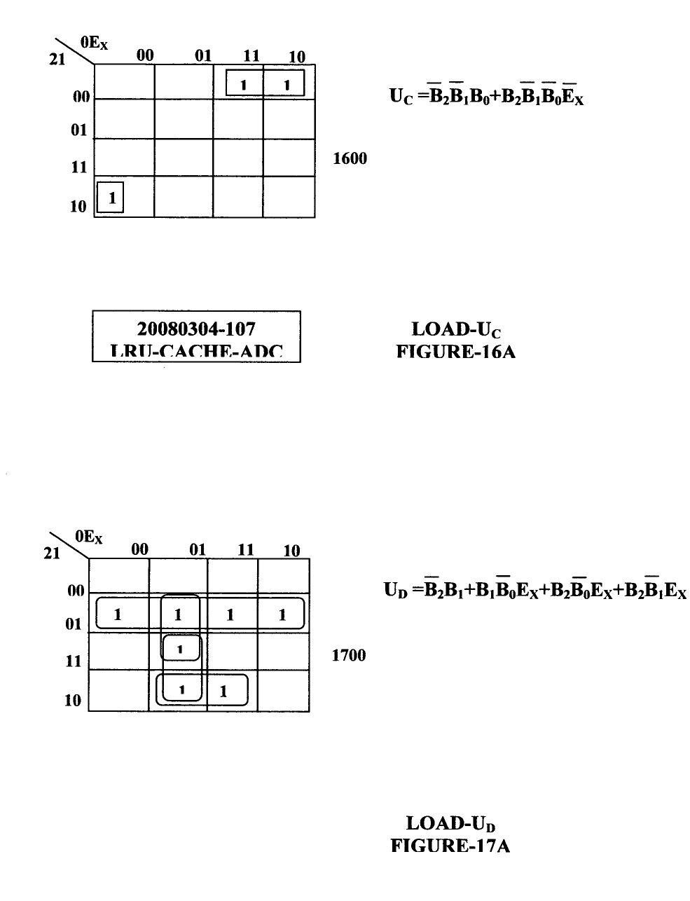

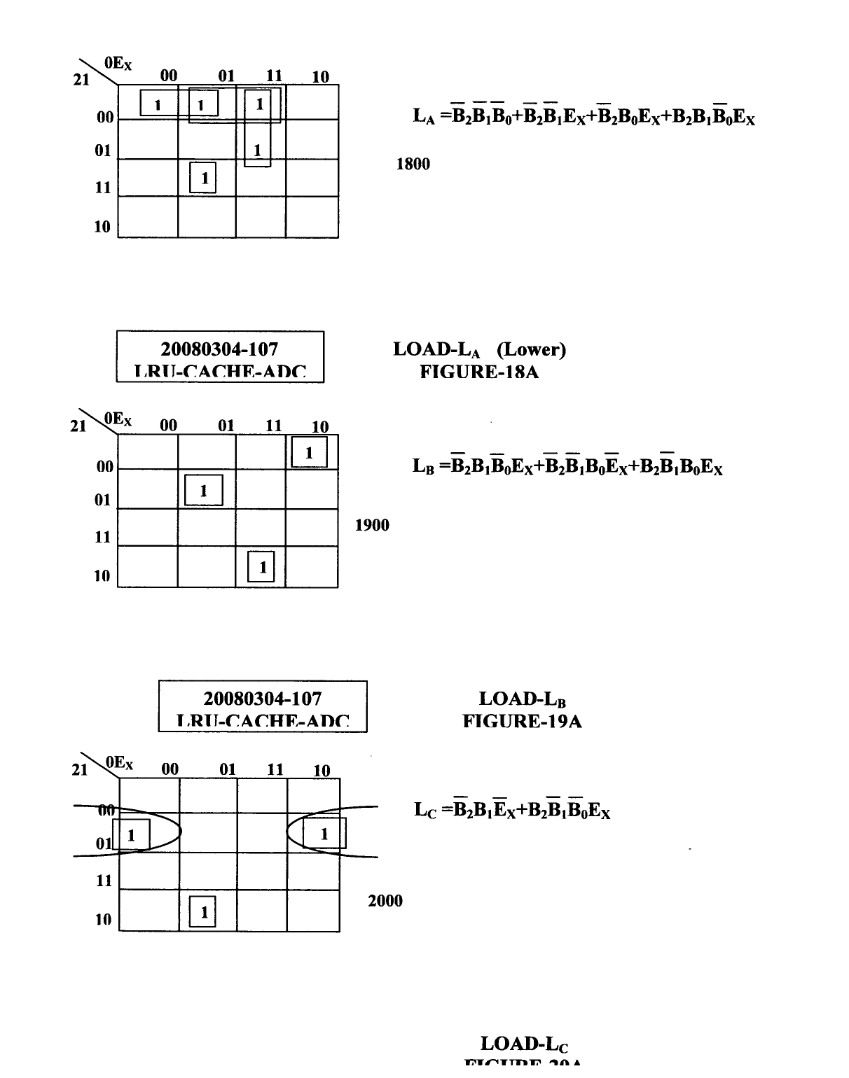

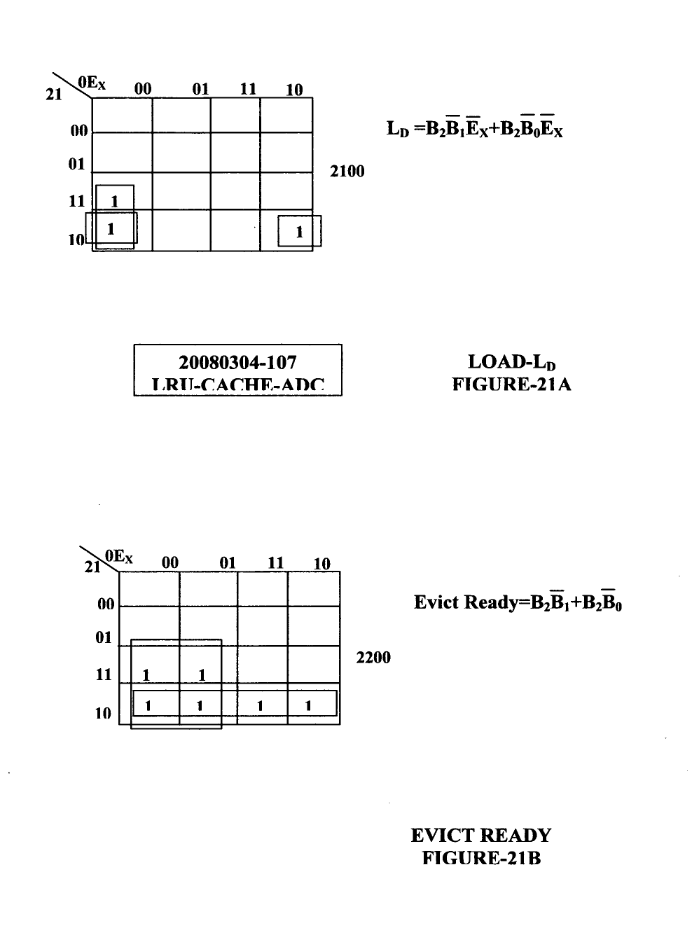

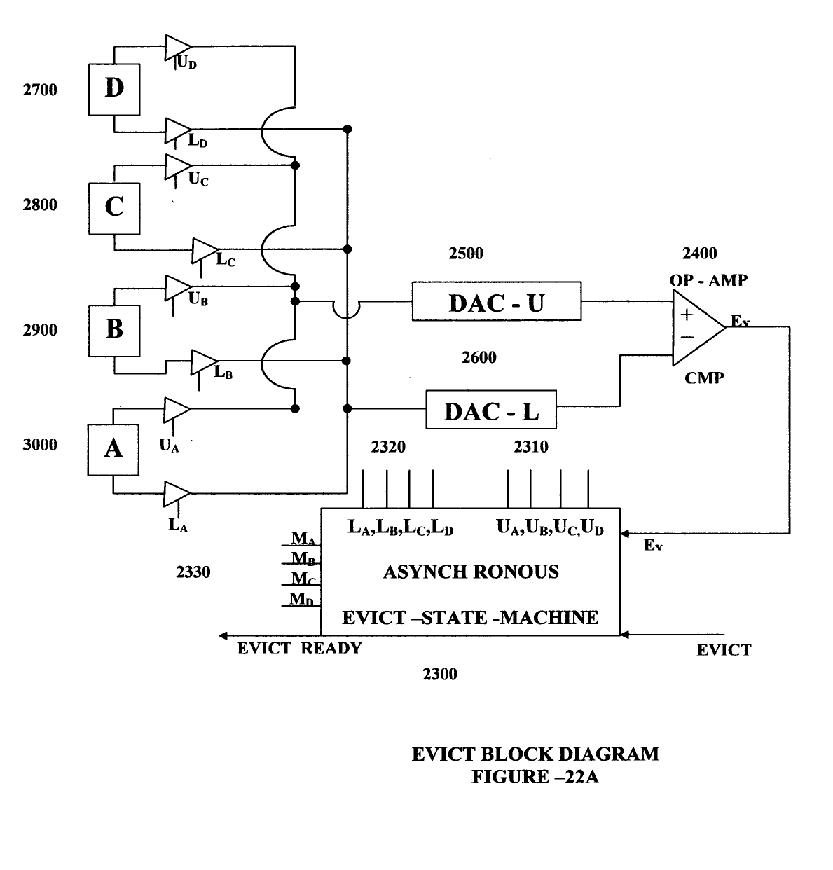

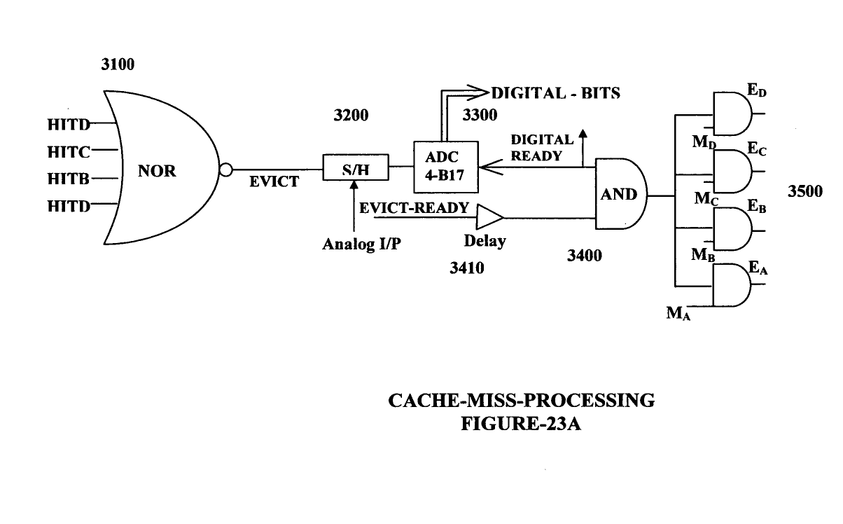

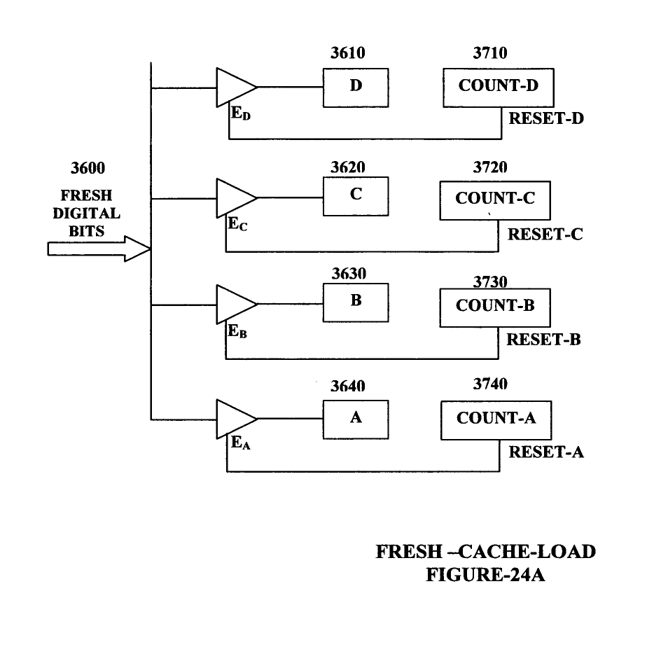

Whenever there is cache, there must be a corresponding policy of CACHE EVICTION. FIG. 3A represents hit counter based LRU (Least recently used) detection of cache entries that need to be thrown out of CACHE and fresh values that correspond to the newer signal need to be loaded! There are 4 CACHE entries in the example design and it is shown in FIG. 3A.

As shown in FIG. 4A, underflows and overflows are detected, and Inc—Increments and Dec—Decrements are controlled. The basic simplified rules are, do not decrement below zero and do not overflow full value for Increment. So OR 7010 takes COUNT bits as inputs and if that CACHE entry has a miss, it will generate Dec signal, which implies decrement my cache hit count. If it is a cache hit and if the count is full (all ones) then AND 7050 and 7060 AND will not generate Inc—Increment signal.

FIG. 5A demonstrates Cache EVICTION with the help of a STATE-MACHINE 8000 and two DAC (Digital to Analog Converters) DAC-U and DAC-L and generating a logic one on EX signal line with the help of OP-AMP CMP, whenever certain conditions satisfy, which are explained more in later FIGURES.

FIG. 6A STATE-MACHINE-EVICTION is a typical state table. P.S. →> Present state is the current state of the state machine, which is represented by 3 memory elements. Ex is from previous Figure, which is an input to the state machine. N.S. is the next state of the machine. M bits are Eviction mark bits. There are four cache entries in the design, so there are 4 Eviction marks, one per each Cache entry. U bits are for routing to higher DAC-U a cache entry value and L bits are for routing to lower DAC-L a cache entry value.

FIG. 7A simply solves for state machine's Next State BITO position value using Present State bits and Ex signal as inputs.

FIG. 8A solves for state machine's Bit1 position.

FIG. 9A solves for state machine's Bit2 position.

FIGS. 10A, 11A, 12A, and 13A eviction trigger signals, which are called Eviction Marks.

FIGS. 14A, 15A, 16A, and 17A shows upper DAC-U load control signals Ua . . . .

FIGS. 18A, 19A, 20A, and 21A shows lower DAC-L load control signals La . . . .

FIG. 21B introduces a new signal EVICT-READY, which means there was a cache miss, and state machine computed which entry needs to be evicted, so that newly computed Digital bits for that stage will be loaded by replacing the old value of the evicted cache slot.

FIG. 22A shows the big picture of Eviction process. Each cache channel is tri-stated and controlled by Un and Ln load signals. So DAC-U 2500 will be loaded with the value of a cache entry, only when its corresponding Un signal allows that Cache entry value to propagate onto DAC-U. Similarly the lower DAC-L will be loaded with the value of a cache entry, only when its corresponding Ln signal allows that Cache entry value to propagate onto DAC-L. Then comparison of DAL-U and DAC-L is done with CMP 2400 and generate an appropriate Ex signal, which is used primarily in the state machine. Computation of all these comparisons are done in analog and for even better speed of computation Asynchronous state machine is designed. It means there is no clock!

FIG. 23A shows overall stages and the blocks involved in CACHE-MISS-PROCESSING. It simply converts Marks to Evicts as shown.

FIG. 24A shows a cache missed signal's corresponding DIGITAL BITS being loaded into Cache using EVICT signals E, after fully initiated computation by a backend ADC.

### DETAILED DESCRIPTION

Cache based Analog to Digital converter has been designed. Its eviction is based on least count, which reflects LRU CACHE scheme.

Upper DAC (300) and lower DAC (400) load the previously matched value into the basic cache ADC cell. It is designed as 8 bit ADC with two stages. 4 cache MSB bits are shown in the example. Value 0715 is loaded into upper DAC (100) inputs. Lower DAC (200) inputs are loaded with value 0700. So if the next I/P signal falls between these two values, CACHE ST/4MISS signal goes high (active). OP-SUB (1000) subtracts 0700 from I/P signal, whose output is the remainder analog signal, which is fed into next ADC stage.

Cache size is 4 in the example. HIT_COUNT is incremented for cache hits and is decremented for cache misses. HIT_COUNT will never increment or decrement and force a carry (overflow). Inc/Dec control logic implementation is shown in FIG. 4A.

STATE MACHINE takes these 4 cache HIT-COUNTS and finds best possible cache entry that needs to be evicted. Entry with the lowest HIT_COUNT gets evicted.

once the data is ready at backend ADC, that data is loaded as fresh cache hit and state machine routes these fresh digital bits into the evicted slot. Tri-state control is used when moving data into cache and HIT-COUNT is reset.

State table for finding a cache entry to be evicted is shown in FIG. 6A. HIT-COUNTS are converted to analog signals. Using comparator (8030) HIT-COUNTS (analog) are compared and control signal Ex is generated. Mark M signals, Upper load U signals, and Lower load L signals are outputs of the state machine. State machine selects a cache entry for eviction. Mark M signals are later converted to Evict E signals, which in turn control strobe-in of digital data into the evicted cache entry.

State transitions are described as follows. State SEvict (000) is the starting (reset) state. Upon reset, state machine enters into state SAB with Ex value don't care. State SAB transitions to state SBC if HIT-COUNT of B is less than HIT-COUNT of A where Ex is logic one, otherwise it transitions to state SAC where Ex is logic zero. State SBC transitions to state SCD when HIT-COUNT of C is less than HIT-COUNT of B with Ex value logic one, otherwise it transition to SBD with Ex value logic zero. State SAC transitions to state SCD when HIT-COUNT of C is less than HIT-COUNT of A with Ex value logic one, otherwise it transitions to SAD with Ex logic zero. State SCD is one of terminating state, but Ex will be logic one, if HIT-COUNT of C is less than that of D implying that HIT-COUNT C is less that of all other HIT-COUNTS, otherwise with Ex logic value zero implying HIT-COUNT D is less that of all other HIT-COUNTS. Similarly there are two other terminating states SBD and SAD.

State machine outputs are described as follows. State SEVICT is a reset state in which DAC-U is loaded with HIT-COUNT B by using tri-state control signal UB, and DAC-L is loaded with HIT-COUNT A by using tri-state control signal LA. State machine always loads assumed lower value DAC-L, and assumed higher value to DAC-U. If DAC-L is lower than DAC-U, Ex is logic zero, otherwise Ex is logic one. Mark signals are generated as follows. When HIT-COUNT B is less than HIT-COUNT A, it generates MB logic one and Ex logic zero, and if that is not true, it generates Ex logic one and MA logic one. State machine does assume in the beginning HIT-COUNT B is lesser than all others and generates MB signal marking B for eviction. But it does not generate final EVICT E signals until all other HIT-COUNTS are evaluated.

EVICT-READY signal is generated, when state machine evaluates all HIT-COUNTS, whose Boolean evaluation is shown in FIG. 21B.

DIGITAL-READY signal gets generated from a smaller backend ADC, which converts Analog signal to DIGITAL BITS, only when there is no corresponding entry in the upfront cache (CACHE MISS). When DIGITAL-READY signal is generated and EVICT-READY is also generated, only then Mark signal gets converted to Evict signals E as shown in FIG. 23A CACHE-MISS-PROCESSING. Instead of solving timing, a delay element is added to EVICT-READY signal for synchronization. DIGITAL-READY is slowly generated for a smaller size backend ADC, when compared to EVICT-READY.

When FRESH DIGITAL BITS are available; it is a simple matter of loading into Cache using EVICT E tri-state signals as control. It is shown in FRESH-CACHE-LOAD FIG. 24A.

What is claimed is:

1. A faster Analog to Digital converter (ADC) is designed by using Cache principles of Digital computing.
Backend ADC can be very small, when compared to full blown ADC implementations. Overall LRU-CACHE-ADC implementation is small in size.
Power consumption is small, when there are cache hits due to smaller number of comparators being switched and backend ADC is not engaged.
Since there are fewer comparators engaged for cached ADC, EMC is better when compared to other ADCS.
Conversion errors are lesser and it is easier to add extra silicon to smaller backend ADC to improve performance and response time.
